(19) United States
(12) Patent Application Publication
(10) Pub. No.: US 2026/0213221 A1
(43) Pub. Date: Jul. 23, 2026

(54) METHOD FOR PRODUCING A MULTI-LAYER, IN PARTICULAR FIVE- OR SIX-LAYER, MEMBRANE-ELECTRODE ARRANGEMENT

(71) Applicant: Robert Bosch GmbH, Stuttgart (DE)

(72) Inventors: Andreas Gehrold, Bamberg (DE); Andy Gottschalk, Lauter (DE); Florian Dirscherl, Bischberg (DE); Peter Reinisch, Kronach (DE)

(21) Appl. No.: 19/140,832

(22) PCT Filed: Dec. 18, 2023
(86) PCT No.: PCT/EP2023/086273

§ 371 Date: Jun. 18, 2025

(30) Foreign Application Priority Data
Dec. 21, 2022 (DE) 10 2022 214 160.1

(51) Int. Cl. H01M 4/86; H01M 4/88

(52) U.S. Cl. CPC H01M 4/8657; H01M 4/8807; H01M 4/8896

(57) ABSTRACT

The invention relates to a method for producing a multi-layer, in particular five-or six-layer, membrane-electrode arrangement (1) comprising a polymer membrane (2), which arrangement has, in order to form an anode (3) and a cathode (4), a catalyst layer (5, 6) and a gas diffusion layer (7, 8) on both sides. According to the invention, the anode-side catalyst layer (5) is applied to the anode-side gas diffusion layer (7) in a wet-chemical coating method, is initially dried, and is joined to the polymer membrane (2) prior to complete drying.

### BACKGROUND

The invention relates to a method for producing a multi-layer, in particular five-or six-layer, membrane-electrode arrangement. The membrane-electrode arrangement is needed in order to produce an electrochemical cell, for example a fuel cell or an electrolysis cell.

Accordingly, the preferred area of application of a membrane-electrode arrangement produced according to the method according to the invention is electrochemical cells.

A membrane-electrode arrangement for an electrochemical cell is constructed in multiple layers. The core is formed by a polymer membrane, which comprises a catalyst layer and a gas diffusion layer on both sides in order to form an anode and a cathode. The membrane-electrode arrangement accordingly comprises at least five layers. At least one film serving as a gasket or sub-gasket can be added as a further layer, which is typically placed between a catalyst layer and a gas diffusion layer.

A layer or ply can in particular be produced in a wet-chemical coating method. Dispersions of ionomers with or without catalysts are applied to a carrier film and dried. The layers produced in this manner can then be joined together in a lamination step.

In practice, the direct coating of a polymer membrane with electrode inks in order to form the catalyst layers has become standard. In this way, the lamination step can be bypassed. However, a challenge here is to coat the solvent-sensitive polymer membrane with a typically solvent-containing electrode ink and then subsequently dry the electrode ink applied as a wet layer.

### SUMMARY

The present invention addresses the problem of simplifying the production of a membrane-electrode arrangement, in particular taking into account the solvent sensitivity of the polymer membrane.

To solve this problem, the method according to the disclosure is proposed.

A method is proposed for producing a multi-layer, in particular five-or six-layer, membrane-electrode arrangement comprising a polymer membrane, which arrangement has, in order to form an anode and a cathode, a catalyst layer, and a gas diffusion layer on both sides. According to the invention, the anode-side catalyst layer is applied to the anode-side gas diffusion layer in a wet-chemical coating method, is initially dried, and is joined to the polymer membrane prior to complete drying.

In contrast to the direct coating of the polymer membrane described above, in the proposed method, the anode-side catalyst layer is applied not to the polymer membrane but rather to the anode-side gas diffusion layer. This typically consists of a carbon fiber mat that is coated on one side in order to form a microporous layer. However, the microporous layer can also be omitted (“low-cost GDL”). The gas diffusion layer is in any case less solvent-sensitive than the polymer membrane, so that applying the anode-side catalyst layer to the anode-side gas diffusion layer is less problematic than directly coating the polymer membrane. Due to the fact that the anode-side catalyst layer applied to the anode-side gas diffusion layer is first dried before being brought into contact with the polymer membrane, the solvent content and thus the stress on the polymer membrane can be lowered.

In the proposed method, in which the anode-side catalyst layer is applied to the anode-side gas diffusion layer by means of a wet-chemical coating method, the gas diffusion layer also serves as a carrier film. Because the gas diffusion layer forms a layer of the multi-layer membrane-electrode arrangement, in this case the carrier film remains in the product. That is to say, less material is consumed and less waste is produced.

Preferably, the anode-side catalyst layer is applied to the side of the anode-side gas diffusion layer that faces the polymer membrane after joining. That is to say, in a gas diffusion layer having a microporous layer on one side, the anode-side catalyst layer is applied to the microporous layer. In a simple gas diffusion layer, after coating with the anode-side catalyst layer, it is to be orientated such that the catalyst layer comes into contact with the polymer membrane. Otherwise, the anode-side catalyst layer cannot be joined to the polymer membrane.

Furthermore, it is proposed that the anode-side catalyst layer is dried via the side of the anode-side catalyst layer that faces the polymer membrane after joining. That is to say, the anode-side catalyst layer is dried via its free side so that the solvent contained in the catalyst layer can be better removed. The drying of the anode-side catalyst layer can be supported by convection and/or heat. For example, infrared radiation can be used as a heat source.

Further preferably, the anode-side catalyst layer is completely dried after joining with the polymer membrane. That is to say, at the time of joining, the anode-side catalyst layer applied to the anode-side gas diffusion layer is not yet solid, but rather is only thickened or gelled, for example, so that it can be used for joining the two joining partners. The drying of the anode-side catalyst layer is preferably done via the side of the anode-side catalyst layer facing the anode-side gas diffusion layer. That is to say, the residual solvent contained in the catalyst layer is removed via the gas diffusion layer. Because this is permeable to the solvent vapors (in contrast to the polymer membrane), drying can be accelerated in this way. At the same time, the contact of the polymer membrane with the solvent is prevented or at least reduced. The complete drying of the anode-side catalyst layer can also be supported by convection and/or heat.

Advantageously, the anode-side gas diffusion layer is provided as a web product and is fed from a roll and/or strip. In this way, membrane-electrode arrangements can be produced inexpensively in large numbers. The anode-side catalyst layer is then applied continuously as a wet layer, preferably in the web direction of the gas diffusion layer.

According to a preferred embodiment of the invention, when applying the anode-side catalyst layer, a respective edge distance to the two lateral edges of the anode-side gas diffusion layer is maintained. That is to say, the side edges of the gas diffusion layer remain uncoated or free. The gas diffusion layer can be joined to at least one further layer via the free side edges. The edge spacing is preferably 1 to 100 mm, further preferably 2 to 5 mm.

In further development of the invention, it is proposed that the polymer membrane is provided as a web product and is fed from a roll for joining with the anode-side catalyst layer. The production process is thereby further simplified, in particular when large quantities are to be produced. The two joining partners are preferably joined under pressure and/or temperature influence. The pressure required for this purpose can be applied, for example, with the aid of the roll that serves to feed the polymer membrane. If the polymer membrane comprises a protective film, it can be removed with the aid of the same or a further roll during feeding.

Preferably, after joining the anode-side catalyst layer to the polymer membrane, the cathode-side catalyst layer is applied to the polymer membrane. The cathode-side catalyst layer can be applied as a wet layer in a wet-chemical coating method or as individual patches by means of a transfer roll. The latter has the advantage that the polymer membrane also comes into contact on the cathode side with as little solvent as possible. Furthermore, drying of the cathode-side catalyst layer applied to the polymer membrane can be omitted, or drying can at least be significantly shortened.

Further preferably, the cathode-side catalyst layer is applied intermittently. In the intermittent application, the cathode-side catalyst layer is applied in a plurality of spaced-apart fields or patches. In this way, material can be conserved, because the catalyst layer is needed only in the region of an active surface of the membrane-electrode arrangement. The intermittent application can be done in both a wet-chemical coating method as well as by means of a transfer roll.

Alternatively or in addition, it is proposed that the cathode-side catalyst layer is applied while maintaining an edge distance to the two side edges of the polymer membrane. In this way, further material can be saved. At the same time, the free side edges of the polymer membrane can be utilized for joining at least one further layer. The edge distance is preferably 1 to 10 mm.

The result of these method steps is an intermediate product comprising four layers, namely the anode-side gas diffusion layer, the anode-side catalyst layer, the polymer membrane, and the cathode-side catalyst layer. The last layer is preferably not contiguous, but is interrupted several times in the web direction, so that only three layers lie on top of one another in these regions. The intermediate product can (with or without separating film) be wound onto a roll and temporarily stored or immediately further processed.

The further processing can in particular consist of a film with window-like openings being applied as a sub-gasket to the cathode-side catalyst layer. The window-like openings serve the purpose of exposing the active surface of the membrane electrode arrangement. For this purpose, the size of the window-like openings is preferably adjusted to the field or patch size of cathode-side catalyst layer. The distances between the fields or patches as well as the edge distance to the side edges of the polymer membrane maintained by the catalyst layer can be used in order to fix the film on the polymer membrane. The application of the film can occur, for example, by means of a hot-melt gluing process or an ultrasonic welding process, so that the film is fixed upon application.

In order to expose the active surface of the membrane-electrode arrangement, the film serving as a sub-gasket is preferably applied in such a way that the window-like openings are arranged in the region of the cathode-side catalyst layer. To fix the film on the polymer membrane, the film serving as a sub-gasket is further applied in such a way that the two side edges of the film project over the side edges of the cathode-side catalyst layer.

Subsequently, the cathode-side gas diffusion layer can be applied, and preferably glued, to the cathode-side catalyst layer and/or the film serving as a sub-gasket.

Provided that a film serving as a sub-gasket is arranged between the cathode-side catalyst layer and the cathode-side gas diffusion layer, the membrane-electrode arrangement produced according to the proposed method has a six-layer construction. When the film is omitted, the membrane-electrode arrangement only has a five-layer construction.

### BRIEF DESCRIPTION OF THE DRAWINGS

A preferred embodiment of the method according to the invention is explained in further detail below with reference to the accompanying drawings. Shown are:

FIG. 1 a schematic cross-section through an electrochemical cell having a membrane-electrode arrangement,

FIG. 2 a schematic diagram of an apparatus for producing a membrane-electrode arrangement according to a method according to the invention,

FIG. 3 a top plan view of a four-layer composite as an intermediate product in the production of a membrane-electrode arrangement,

FIG. 4 a top plan view of the four-layer composite including the sub-gasket, and

FIG. 5 a top plan view of the finished membrane-electrode arrangement.

### DETAILED DESCRIPTION

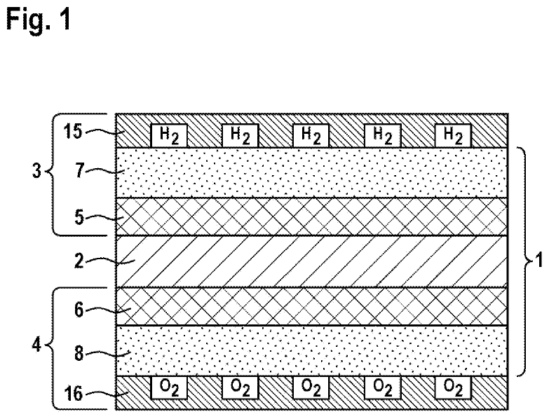

FIG. 1 shows a conventional membrane-electrode arrangement 1 comprising five layers and framed on the outside by embossed sheets 15, 16 forming a gas distributor structure for the respective reaction gas.

The core of the membrane-electrode arrangement 1 forms a polymer membrane 2 on which a catalyst layer 5, 6 is arranged on both sides in order to form an anode 3 and a cathode 4. A gas diffusion layer 7, 8 is arranged on the catalyst layers 5, 6, via which the respective reaction gas is supplied to the cathode layers 5, 6, respectively.

The method according to the invention can be used in order to produce such a five-layer membrane-electrode arrangement 1. However, six-layer membrane electrode arrangements 1 can also be produced using the method according to the invention. In this case, the sixth layer forms a film 13 serving as a sub-gasket. The method according to the invention is explained below using the example of the production of a six-layer membrane-electrode arrangement 1.

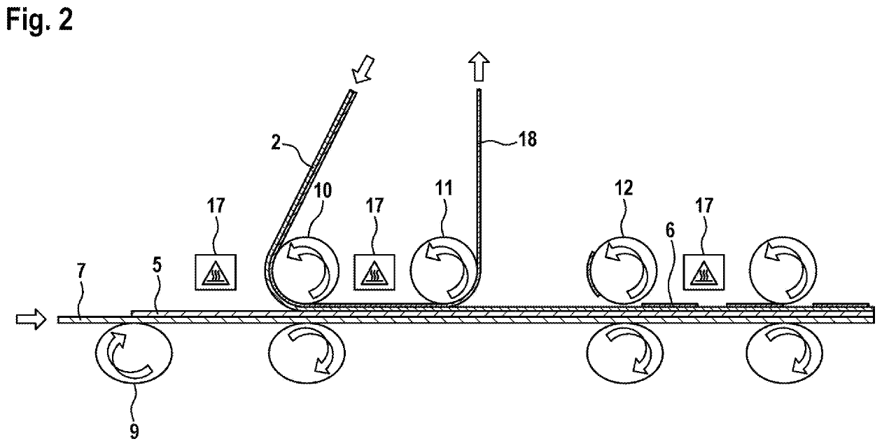

FIG. 2 shows an apparatus for producing a multi-layer membrane-electrode arrangement 1 according to a method according to the invention. The apparatus comprises a plurality of rolls 9, 10, 11, 12, each serving for the application and/or transport of a layer.

An anode-side gas diffusion layer 7, which is configured as a web product, is fed via a first roll 9. It serves as the support layer for the further layers. In a wet-chemical coating method, an anode-side catalyst layer 5 is then applied to the anode-side gas diffusion layer 7. This forms a wet layer on the anode-side gas diffusion layer 7, which is dried with the aid of a heating device 17. During the drying, the solvents contained in the wet layer volatilize. Before the anode-side catalyst layer 5 is completely dried, a polymer membrane 2 is applied with the help of a second roll 10. With the help of a third roll 11, a protective film 18 arranged on the polymer membrane is removed. A further heating device 17 is arranged between the two rolls 10, 11 in order to support the complete drying of the anode-side catalyst layer 5 after application of the polymer membrane 2. Because the anode-side catalyst layer 5 is already dried during the joining with the polymer membrane 2, the solvent content is reduced so that the solvent-sensitive polymer membrane 2 is protected.

A cathode-side catalyst layer 6 is subsequently applied to the polymer membrane 2, namely with the aid of a transfer roll 12. The application occurs in the form of individual patches, which are placed a distance from one another on the polymer membrane 2. With the support of a heating device 17, the cathode-side catalyst layer 6 can be dried. With the application of the cathode-side catalyst layer 6, there is a four-layer composite, i.e. at least one layer is still missing.

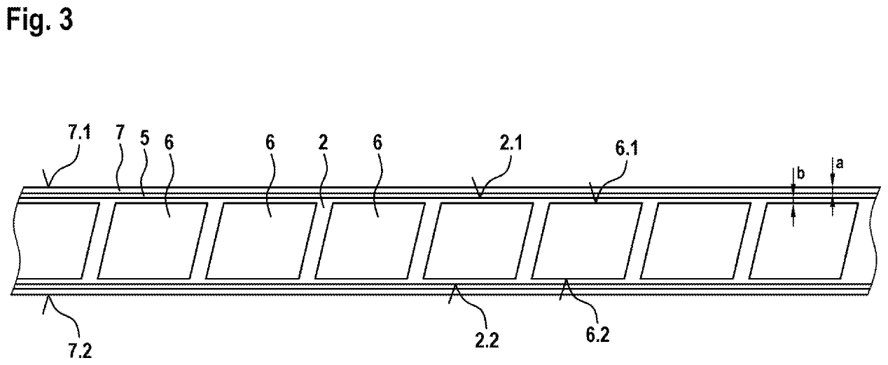

In FIG. 3, an exemplary top plan view of the four-layer composite is shown. The anode-side gas diffusion layer 7 is arranged at the very bottom and with protruding side edges 7.1, 7.2. This is followed by the anode-side catalyst layer 5, which is formed continuously in the web direction of the gas diffusion layer 7 but maintains a respective edge distance a to the two side edges 7.1, 7.2 of the anode-side gas diffusion layer 7. The polymer membrane 2 applied, which is also continuously formed in the web direction, is applied to the anode-side catalyst layer 5. The cathode-side catalyst layer 6, which is configured in the form of individual patches, is in turn arranged on the polymer membrane 2. These are not only arranged spaced apart from one another, but rather also maintain an edge distance b to the side edges 2.1, 2.2 of the polymer membrane 2. The side edges 6.1, 6.2 of the cathode-side catalyst layer 6 are thus arranged spaced apart from the side edges 2.1, 2.2 of the polymer membrane 2.

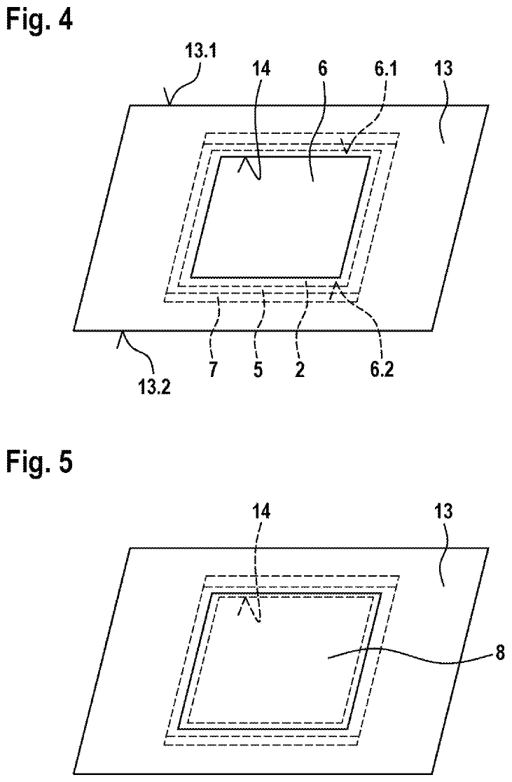

To form a sub-gasket, a film 13 can be placed on the four-layer composite as the fifth layer. The five-layer composite is shown by way of example in a top plan view in FIG. 4. The film 13 projects over all other layers so that its side edges 13.1, 13.2 protrude laterally. The film 13 has window-like openings 14 that expose the cathode-side catalyst layer 6. The further layers arranged below the cathode-side catalyst layer 6 can also be seen through the film 13.

Finally, a cathode-side gas diffusion layer 8 is applied to the five-layer composite of FIG. 4, so that now a six-layer composite or a six-layer membrane electrode arrangement 1 with a sub-gasket is given. This is illustrated by way of example in the top plan view in FIG. 5.

1. A method for producing a multi-layer membrane-electrode arrangement (1) comprising a polymer membrane (2), which arrangement has, in order to form an anode (3) and a cathode (4), a catalyst layer (5, 6) and a gas diffusion layer (7, 8) on both sides,
wherein the anode-side catalyst layer (5) is applied to the anode-side gas diffusion layer (7) in a wet-chemical coating method, is initially dried, and is joined to the polymer membrane (2) prior to complete drying.

2. The method according to claim 1,
wherein the anode-side catalyst layer (5) is applied to a side of the anode-side gas diffusion layer (7) that faces the polymer membrane (2) after joining.

3. The method according to claim 2,
wherein the anode-side catalyst layer (5) is dried via the side of the anode-side catalyst layer (5) that faces the polymer membrane (2).

4. The method according to claim 1,
wherein the anode-side catalyst layer (5) is dried completely after joining with the polymer membrane (2).

5. The method according to claim 1,
wherein the anode-side gas diffusion layer (7) is provided as a web product and is fed from a roll (9) and/or a tape.

6. The method according to claim 1,
wherein, when applying the anode-side catalyst layer (5), a respective edge distance (a) to two side edges (7.1, 7.2) of the anode-side gas diffusion layer (7) is observed.

7. The method according to claim 1,
wherein the polymer membrane (2) is provided as a web product and is fed from a roll (10) for joining with the anode-side catalyst layer (5).

8. The method according to claim 1,
wherein, after joining the anode-side catalyst layer (5) to the polymer membrane (2), the cathode-side catalyst layer (6) is applied to the polymer membrane (2).

9. The method according to claim 8,
wherein the cathode-side catalyst layer (6) is applied intermittently and/or while maintaining an edge distance (b) to two side edges (2.1, 2.2) of the polymer membrane (2).

10. The method according to claim 1,
wherein a film (13) with window-like openings (14) is applied as a sub-gasket to the cathode-side catalyst layer (6).

11. The method according to claim 10,
wherein the film (13) is applied such that the window-like openings (14) are arranged in a region of the cathode-side catalyst layer (6), and/or two side edges (13.1, 13.2) of the film (13) project over side edges (6.1, 6.2) of the cathode-side catalyst layer (6).

12. The method according to claim 10,
wherein the cathode-side gas diffusion layer (8) is applied, to the cathode-side catalyst layer (6) and/or the film (13) serving as a sub-gasket.

13. The method according to claim 1, wherein the multi-layer membrane-electrode arrangement (1) includes five or six layers.

14. The method according to claim 3, wherein the drying is conducted by convection and/or heat.

15. The method according to claim 5, wherein the anode-side catalyst layer (5) is applied continuously as a wet layer in a web direction of the gas diffusion layer (7).

16. The method according to claim 6, wherein the respective edge distance (a) is 1 to 100 mm.

17. The method according to claim 16, wherein the respective edge distance (a) is 2 to 5 mm.

18. The method according to claim 8, wherein the cathode-side catalyst layer (6) is applied to the polymer membrane (2) as a wet layer in a wet-chemical coating method or as individual patches by a transfer roll (12).

19. The method according to claim 9, wherein the edge distance (b) is 1 to 10 mm.

20. The method according to claim 10, wherein the film (13) with window-like openings (14) is applied as a sub-gasket to the cathode-side catalyst layer (6) by a hot-melt gluing method or an ultrasonic welding method.
